(19) United States
(12) Patent Application Publication
(10) Pub. No.: US 2007/0051770 A1
(43) Pub. Date: Mar. 8, 2007

(54) STORAGE AND DISPENSING DEVICE FOR MATERIALS ON ROLLS

(75) Inventor: David Berg, White Lake, MI (US)

Correspondence Address: GIFFORD, KRASS, GROH, SPRINKLE & CITKOWSKI, P.C, PO BOX 7021, TROY, MI, 48007-7021, US

(73) Assignee: DGB Ideas, LLC, Waterford, MI (US)

(21) Appl. No.: 11/470,020

(22) Filed: Sep. 5, 2006

Related U.S. Application Data
(60) Provisional application No. 60/713,968, filed on Sep. 2, 2005.

(51) Int. Cl. B26F 3/02

(52) U.S. Cl. 225/6

(57) ABSTRACT

A storage and dispensing device for material provided on rolls includes a base and a material holder. The base has an outer shell, an opening and an interior space defined within the outer shell. The material holder has a stowed position wherein the holder is disposed at least partially in the interior space and a dispensing position wherein the holder at least partially extends from the base. The holder includes a plurality of elongated dispensing tubes each configured to receive a roll of material. Each tube has an opening for dispensing material from the roll.

### REFERENCE TO RELATED APPLICATION

This application claims priority from U.S. Patent Application Ser. No. 60/713,968, filed Sep. 2, 2005, the entire content of which is incorporated herein by reference.

### FIELD OF THE INVENTION

The present invention relates generally to storage and dispensing devices and, more specifically, to a device for holding and dispensing material from rolls.

### BACKGROUND OF THE INVENTION

There is an ongoing need for devices to assist in organizing the various items and materials found in consumers' homes. As one example, many consumers use material that comes on rolls such as plastic wrap, aluminum foil, wax paper, etc. These are typically used in a kitchen and come in individual boxes each holding one roll of material. These individual boxes and rolls often clutter a drawer or cabinet in the kitchen making it difficult to locate and retrieve the particular material the consumer seeks.

A similar concern arises with wrapping paper, shipping paper, and other rolled goods used elsewhere in the home. Wrapping paper is a particular example because it is used intermittently, is preferably kept neat and clean, and requires substantial storage space.

### SUMMARY OF THE INVENTION

The present invention provides a storage and dispensing device for material provided on rolls. The device includes a base and material holder. The base has an outer shell, an opening, and an interior space defined within the outer shell. The material holder is received through the opening of the base and has a stowed position wherein the holder is disposed at least partially in the interior space and a dispensing position wherein the holder at least partially extends from the base. The material holder includes a plurality of elongated dispensing tubes each configured to receive a roll of material therein. The dispensing tubes each have an opening defined therein for dispensing material from the roll. The material holder is movable to the dispensing position such that material may be dispensed from one of the tubes.

In a first alternative embodiment, the storage and dispensing device has a base and a sliding and pivoting tray. The base has an outer shell, an opening and an interior space defined within the outer shell. The sliding and pivoting tray is movably received through the opening of the base. The tray has a stowed position wherein the tray is disposed at least partially in the interior space and a dispensing position wherein the tray is linearly slid at least partially out of the base and pivoted with respect to the base. The tray further includes a plurality of roll supports each configured to support a roll of material such that the material can be dispensed from the roll.

In a further embodiment, a storage and dispensing device includes a material holder with a plurality of elongated dispensing tubes each configured to receive a roll of material therein. The dispensing tubes each having an opening defined therein for dispensing material from the roll. At least one cutter is provided for cutting material dispensed from the dispensing tubes thru the openings.

### BRIEF DESCRIPTION OF THE DRAWINGS

FIG. 1 is a perspective view of a first preferred embodiment of a storage and dispensing device according to the present invention, with the material holder or tray shown in the dispensing position;

FIG. 2 is a perspective view of the storage and dispensing device of FIG. 1 with the material holder or tray in the stowed position;

FIG. 3 is a detailed cross-sectional view of an end of one version of a cutter that forms part of some embodiments of the present invention;

FIG. 4 is a detailed perspective view of a portion of the material holder or tray showing a roll of material being inserted into one of the dispensing tubes and a retaining ring and spindle member positioned for assembly to the remainder of the material holder or tray;

FIG. 5 is a detailed perspective view of an opposite side of the material holder or tray showing an end of a roll of material positioned to be received on a spindle member for supporting the roll within the dispensing tube; and

FIG. 6 is a detailed perspective view of the material holder or tray showing material being disposed in two of the dispensing tubes with the material extending from one of the tubes and being cut by the cutter

### DETAILED DESCRIPTION OF THE PREFERRED EMBODIMENTS

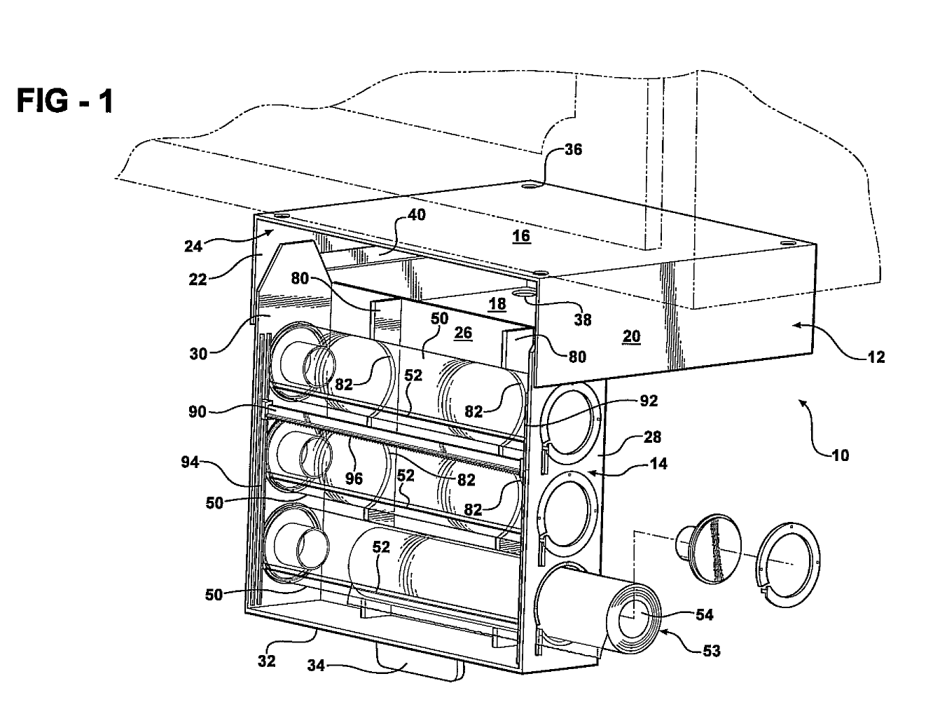

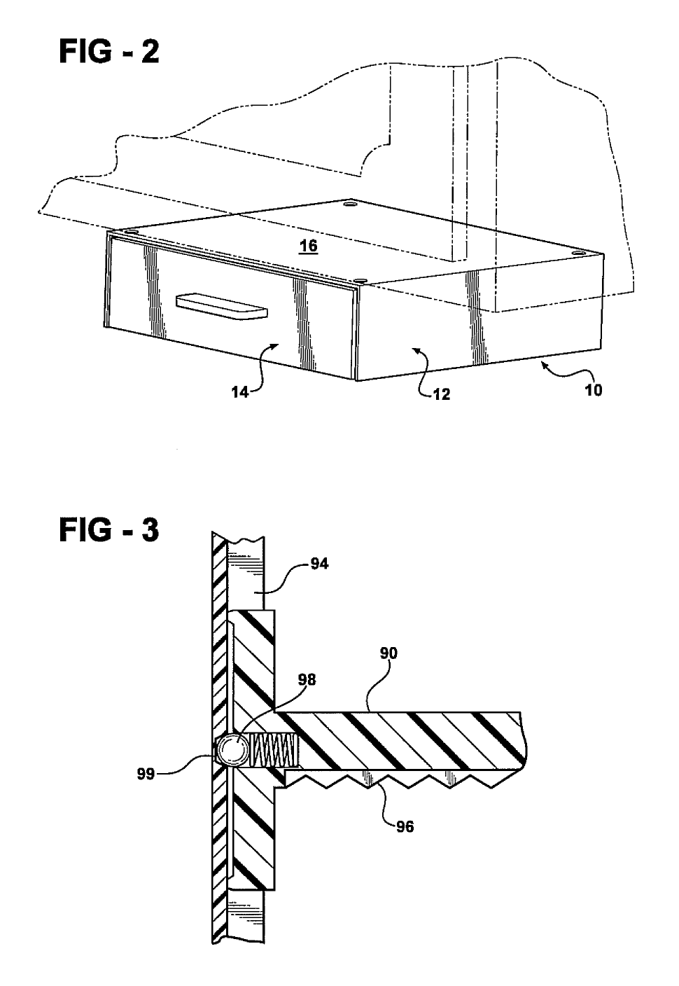

The present invention provides multiple embodiments of devices for storing and/or dispensing material that is typically found on a roll. A first embodiment of such a device is shown in FIGS. 1-6. A first preferred embodiment of the storage device 10 includes a base 12 that receives a material holder or tray 14. The base may be placed on a counter, inside a cabinet or drawer, or mounted on or underneath a surface such as the underside of a cabinet as shown in FIGS. 1 and 2. In the illustrated embodiment, the base 12 has a top 16, a bottom 18 and a pair of sides 20 and 22 extending between the top and bottom. The top 16, bottom 18 and sides 20 and 22 cooperate to define an exterior shell with an opening 24 communicating with an interior space of the shell. The holder or tray 14 is received through the opening 24 into this interior space and may be slid into and out of the base. In FIG. 14, the base 12 is shown mounted horizontally with the holder or tray 14 pulled out and folded downwardly. As will be clear to those of skill in the art, the slide and pivot mechanism may take many forms, any of which may be utilized with the present invention.

The position of the holder or tray 14 illustrated in FIG. 1 may be referred to as the dispensing position, wherein the holder or tray at least partially extends out of the base. The position of the holder or tray 14 illustrated in FIG. 2 may be referred to as a stowed position wherein the holder or tray is disposed at least partially in the interior space of the base 12. In the preferred and illustrated embodiment, the holder or tray 14 slides linearly and pivots with respect to the base. However, in alternative embodiments, the holder or tray 14 may be limited to just a sliding motion or to just a pivoting motion. For example, the holder or tray 14 could merely pivot downwardly out of the base to allow access to material disposed in the holder or tray 14. Alternatively, an articulating linkage may be provided so as to articulate the holder or tray between a stowed position and a dispensing position.

Referring again to FIG. 1, the holder or tray 14 is formed so as to be drawer-like and has a bottom 26 extending between a pair of opposed sides 28 and 30 and a front 32 which extends generally perpendicularly from the bottom 26 and also extends between the opposed sides 28 and 30. The front 32 may include a handle 34 for moving the holder or tray 14 between the stowed and dispensing positions.

In the illustrated embodiment, the base 12 is formed by a top 16, bottom 18 and sides 20 and 22 that are each generally continuous planar members. In the illustrated embodiment, the top 16 has a plurality of fastener holes 36 for fastening the base to the underside of a cabinet, as shown. The bottom 18 has corresponding access holes 38 for installing fasteners through the fastener holes 36. As an alternative, the top 16, bottom 18 and/or sides 20 and 22 may have additional openings or holes provided therein so as to reduce the amount of material required to form the base. The base may also be formed as a more open design than illustrated. Likewise, the holder or tray 14 may have a variety of openings or holes to reduce material usage. Alternatively, the bottom 26 may be eliminated in some embodiments.

In the illustrated embodiment, a guide slot 40 is defined in the inner surface of each side 20 and 22, though only one of the guide slots 40 is visible in FIG. 1. The holder or tray 14 preferably has corresponding circular protrusions extending from each of the sides 28 and 30. These protrusions are positioned near what is the uppermost end of the sides 28 and 30 when the holder or tray 14 is positioned as shown in FIG. 1. These protrusions engage the guide slots 40, thereby allowing the holder to linearly slide at least partially out of the base 12 and to pivot downwardly, as shown. As will be clear to those of skill in art, the bottom 18 of the base extends forwardly less far than the top 16, thereby allowing the downwardly pivoting motion of the holder or tray 14. This bottom may also act as a stop for the pivoting of the holder or tray 14.

As shown in FIG. 1, the material holder or tray 14 includes a plurality of dispensing tubes 50 for receiving and supporting material provided on rolls. An exemplary roll of material is shown at 53 being inserted into the lowermost dispensing tube 50. Such a roll of material 53 typically has a central core 54 about which sheet material is wrapped. Alternatively, some such rolls of material lack a central core, with the material itself forming its own core. The roll of material 53 preferably has a cylindrical opening through the center.

The tubes 50 preferably are generally cylindrical tubes formed of a clear or translucent material, such as a clear plastic. In this embodiment, the dispensing tubes 50 extend between the opposed sides 28 and 30 of the material holder or tray 14. In the illustrated embodiments, the tubes 50 are preferably fixed to the remainder of the material holder or tray 14 such that they do not rotate or translate with respect thereto. Alternatively, the tubes 50 may be moveable and/or removable. The dispensing tubes 50 each further include an opening 52 defined in the tube for dispensing material. In the illustrated embodiment, the openings 52 are each elongated slots that extend along the length of the clear dispensing tubes 50. In the illustrated embodiment, the slots 52 extend the entire length of the tubes 50. Alternatively, they may extend less than the entire length, depending on the configuration of the overall device. As illustrated, the slots are preferably positioned no directly on the front of each tube, but instead rotated downwardly, with respect to the position shown in FIG. 1. When viewed from the side 28, the slot may be said to be positioned between the 6 o'clock and 9 o'clock positions, or more specifically at about the 8 o'clock position.

While the tubes 50 are preferably clear or translucent, they may alternatively be opaque and/or may include openings or translucent or clear windows therein such that the material disposed in each tube is visible from the outside. Additionally, the slots 52 may be positioned or dimensioned differentially than shown.

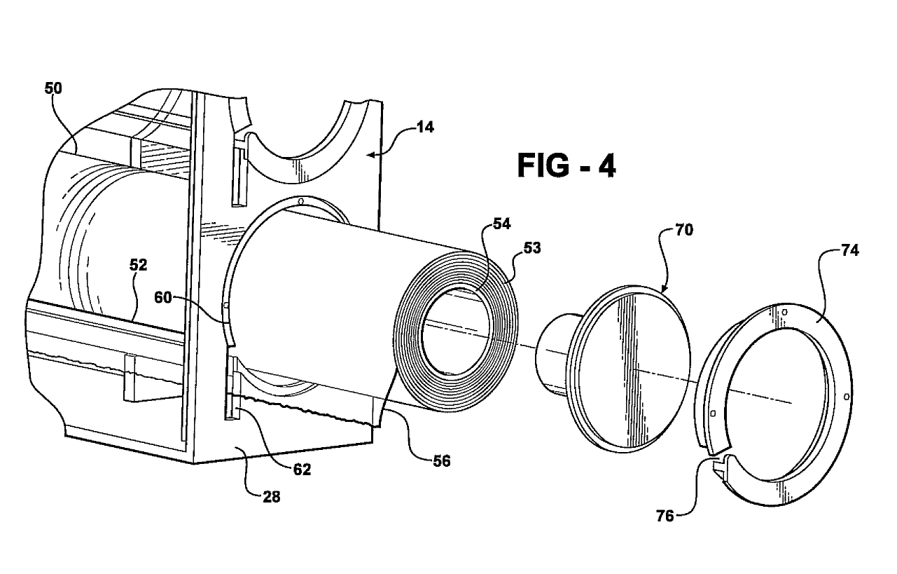

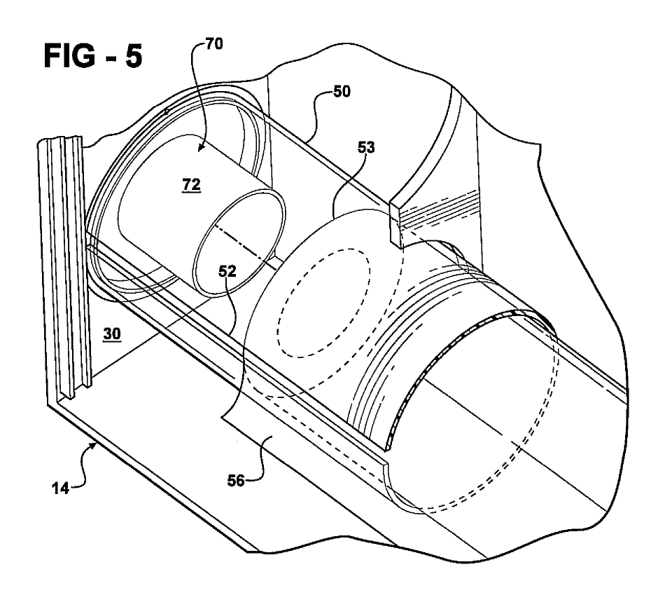

Referring now to FIG. 4, a detailed view is provided showing the roll of material 53 as it is inserted into one of the tubes 50 in the material holder or tray 14. In a preferred approach, a leading portion 56 of the material from the roll 53 is extended from the roll prior to insertion of the roll into the tube 50. As shown, the side 28 has an opening 60 defined therein which is aligned with the end of the tube 50. This opening 60 is generally circular so as to match the shape of the tube 50. In addition, the opening includes an extension 62 that extends from the side of the generally circular opening. This extension 62 extends outwardly and generally downwardly from the circular portion of the opening, though it may have other shapes and configurations. In the preferred approach, the leading portion 56 is positioned in this extension 62 as the roll of material 53 is fed through the opening 60. The extension 62 is aligned with the end of the slot 52 and the tube such that as the leading portion 56 is fed through the extension 62 it is also fed into the slot 52. Therefore, once the roll 53 is received in the tube 50, the leading portion 56 is already extending through the slot 52 and ready for use. Referring now to FIG. 5, the opposite end of the roll of material 53 is shown as it approaches the opposite side 30 of the material holder or tray 14. As shown, the leading portion 56 is positioned in the slot 52. In a preferred embodiment of the present invention, a spindle member 70 is provided which extends from the side 30 so as to be received in the opening in the end of the roll 54. The spindle member 70 preferably supports the roll 53 generally centered in the tube 50 to allow for easier rotation of the roll and dispensing of material. The spindle member has a generally cylindrical portion 72 which extends from the side 30 and is generally coaxial with the tube 50. The size and length of the generally cylindrical portion 72 may be altered from the illustrated version depending on the typical or expected size of the opening in the end of the roll of material 53.

Referring again to FIG. 4, another spindle member 70 is illustrated positioned so as to be inserted in the end of the roll of material 53. In preferred embodiments, after the roll of material 53 is inserted into the dispensing tube 50, a spindle member 70 is inserted so as to close the opening 60 and support the end of the roll of material 53. A retaining ring 74 may be provided to retain the spindle member. Alternatively, the spindle member may engage the remainder of the material holder or tray 14 in other ways, such as making the spindle member and retaining ring a unitary piece. As a further alternative, the retaining ring 74 may remain in place and make serve the further function of retaining the end of the dispensing tube 50. In this case, the roll of material may be inserted through the opening in the center of the retaining ring, which has a cut portion 76 that aligns with the extension 62 of the opening 60.

Preferably, the material holder or tray 14 is constructed generally symmetrically side-to-side such that the spindle member 70 may be removed from either end of the tube 50, an old material roll may be removed and a new material roll inserted from either end. This allows use in positions where either side of the device is not easily accessible for inserting a new roll of material. Alternatively, only a single side may be accessible. As will be clear to those of skill in the art, other approaches may be provided for loading the ends of the tubes 50. As a further alternative, another embodiment of the present invention may exclude the tubes 50 and support the rolls of material in another way, such as on spindles without a surrounding tube. Referring now to FIG. 1, the preferred embodiment of the present invention includes support members 80 that extend from the bottom 26 and provide further support for the dispensing tubes 50. Each support member has arcuate-shaped cut-outs 82 such that the support members can engage the backside of each tube, thereby supporting the tube 50. The tubes may be merely supported by the support members 80, or may be adhered or otherwise attached thereto. In one example, the tubes 50 snap into the arcuate cut-outs 82.

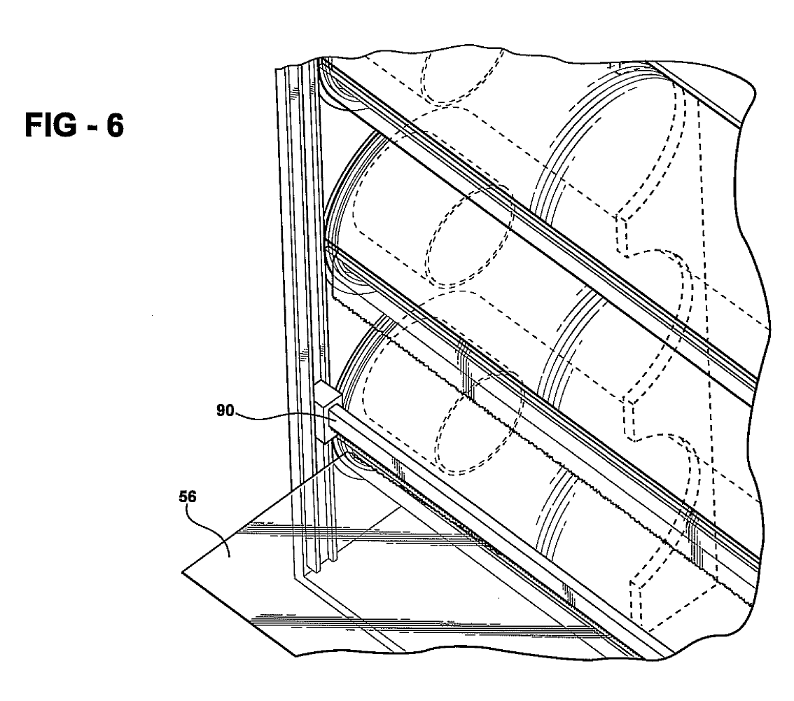

As shown in FIG. 1, preferred embodiments of the present invention further include a cutter 90 for cutting material dispensed from rolls of material, such as the roll of material 53. The cutter 90 may take a variety of forms, and a single or multiple cutters may be provided. In the preferred and illustrated embodiment, a single cutter 90 is provided that slides upwardly and downwardly in a pair of tracks 92 and 94 defined on the inner surfaces of the sides 28 and 30 of the material holder or tray 14. The cutter has a sharpened or serrated lower cutting edge 96 for cutting material dispensed from one of the rolls. Alternatively, the cutting edge may be on the upper side of the cutter. FIG. 6 illustrates a leading portion 56 of material from a roll being separated from the remainder of the roll by cutting using the cutter 90. The leading portion 56 of the material may be lifted and torn off against the cutter. Alternatively, the cutter may be moved downwardly, or may have a slide cutting mechanism that can be slid side-to-side to cut-off the leading portion of the material. Preferably, the cutter may be moved upwardly and downwardly such that it is positioned for cutting material from any of the rolls. In some embodiments, a detent is provided for positioning the cutter in the proper position. FIG. 3 shows a cross-sectional view of the end of the cutter 90 with the detent mechanism 98 engaging a detent 99 in the track 94. As will be clear to those of skill in the art, other detent or positioning mechanisms may be used in addition to or in place of the illustrated versions.

As will be clear to those of skill in the art, the storage and dispensing device according to the present invention may be altered in a variety of ways without departing from the scope or teaching of the present invention. As one example, the device may be provided with more or fewer than the three dispensing tubes illustrated. Further, the tubes may be bigger or smaller, and longer or shorter than illustrated. The material holder or tray may take different forms than illustrated, such as being a more open assembly without generally planar sides that define the outermost sides of the holder or tray 14. For example, the tubes 50 could be supported by support members such as 80 in a more open holder or tray. Further, a storage and dispensing device according to the present invention may take the form of the holder or tray without the base. For example, such a device could be placed in a drawer where a further enclosure is not required. As a further alternative, such a device could be provided with a lid that covers the holder or tray and can be opened for access to the dispensing mechanism. The dispensing tubes 50 are illustrated as all being disposed in a common plane and being parallel to each other. This configuration may also be altered, such as positioning the tubes in a generally curved plane or in a non-parallel arrangement. Alternative cutting mechanisms may also be provided, such as providing a fixed cutter aligned with each tube such that the cutter 90 does not have to moved upwardly and downwardly. As a further alternative, the cutter may be eliminated, with the edge of the slot 52 and the tube 50 acting as the cutting element. The edge may be sharpened or not sharpened, depending on the material to be cut. The slot 52 and the tubes may also take different shapes, such as having an extended portion that acts as a guide for the material. Such a shaped opening may mirror the opening of the extension 62, or may take other shapes and configurations. As a further alternative, the spindle members 70 may be replaced with an elongated spindle or support that extends through the entire center of the role, such as is typical with some paper towel holders. Yet another alternative is to provide spindles or spindle members that support the ends of the rolls and not to use dispensing tubes. The storage and dispensing device according to the present invention may be altered to provide holders for other materials, such as having receiving areas for boxes of sandwich bags or other materials. For example, a version may be provided that holds several boxes, as well as one or more rolls of material.

Further variations on the herein disclosed embodiments of the present invention will be clear to those of skill in the art.

I claim:

1. A storage and dispensing device for material provided on rolls, the storage and dispensing device comprising:
a base having an outer shell, an opening, and an interior space defined within the outer shell; and
a material holder received through the opening of the base, the material holder having a stowed position wherein the holder is disposed at least partially in the interior space and a dispensing position wherein the holder at least partially extends from the base, the material holder including a plurality of elongated dispensing tubes each configured to receive a roll of material therein, the dispensing tubes each having an opening defined therein for dispensing material from the roll;
wherein the material holder is movable to the dispensing position such that material may be dispensed from one of the material tubes.

2. The storage and dispensing device of claim 1, wherein:
the material holder comprises a tray that is linearly slidable and pivotable with respect to the base, the movement of the tray from the stowed position to the dispensing position comprising linearly sliding the tray at least partially out of the base and then pivoting the tray with respect to the base.

3. The storage and dispensing device of claim 1, wherein:
each of the plurality of dispensing tubes is at least partially clear such that material disposed within the tube is visible from outside the tube, the opening in each tube being an slot defined along the length of the tube.

4. The storage and dispensing device of claim 3, wherein substantially the entirety of each tube is formed of a material that is at clear or translucent.

5. The storage and dispensing device of claim 3, wherein:
the material holder comprises a tray having a pair of spaced apart sides, the plurality of dispensing tubes being disposed generally parallel to each other in a common plane, each tube extending between the spaced apart sides of the tray.

6. The storage and dispensing device of claim 3, wherein the dispensing tubes are fixed to the material holder.

7. The storage and dispensing device of claim 17 wherein the material holder further comprising at least one spindle member disposed coaxially with each dispensing tube for supporting an end of a roll disposed therein.

8. The storage and dispensing device of claim 1, wherein the material holder further comprises a cutter for cutting material dispensed from at least one of the rolls.

9. The storage and dispensing device of claim 8, wherein the cutter is movable along the material holder for cutting material dispensed from each of the rolls.

10. A storage and dispensing device for material provided on rolls, the storage and dispensing device comprising:
a base having an outer shell, an opening, and an interior space defined within the outer shell; and
a sliding and pivoting tray movably received through the opening of the base, the tray having a stowed position wherein the tray is disposed at least partially in the interior space and a dispensing position wherein the tray is linearly slid at least partially out of the base and pivoted with respect to the base, the tray further including a plurality of roll supports each configured to support a roll of material such that material can be dispensed from the roll.

11. The storage and dispensing device of claim 10, wherein:
each of the plurality of roll supports is an at least partially clear dispensing tube for receiving the roll of material therein, wherein material disposed within the tube is visible from outside the tube, each tube having an opening for dispensing material from the roll.

12. The storage and dispensing device of claim 11, wherein substantially the entirety of each tube is formed of a material that is at clear or translucent.

13. The storage and dispensing device of claim 11, wherein:
the tray has a pair of spaced apart sides, the plurality of dispensing tubes being disposed generally parallel to each other in a common plane, each tube extending between the spaced apart sides of the tray.

14. The storage and dispensing device of claim 10, wherein the tray further comprising at least one spindle member for supporting an end of a roll.

15. The storage and dispensing device of claim 10, wherein the tray further comprises a cutter for cutting material dispensed from at least one of the rolls.

16. The storage and dispensing device of claim 15, wherein the cutter is movable along the tray for cutting material dispensed from each of the rolls.

17. A storage and dispensing device for material provided on rolls, the storage and dispensing device comprising:
a material holder including a plurality of elongated dispensing tubes each configured to receive a roll of material therein, the dispensing tubes each having an opening defined therein for dispensing material from the roll; and
at least one cutter for cutting material dispensed from the dispensing tubes thru the openings.
